(19) United States
(12) Patent Application Publication
(10) Pub. No.: US 2014/0261012 A1
(43) Pub. Date: Sep. 18, 2014

(54) COOKING GRILL HAVING RACK SUPPORTING INDIVIDUAL GRILLING MODULES

(71) Applicant: SEASON 4, LLC, Charlotte, NC (US)

(72) Inventors: Juan Carlos Perez, Jr., Charlotte, NC (US); Louis J. Foreman, Huntersville, NC (US); Todd Stancombe, Charlotte, NC (US); Ryan Shane Gorman, Charlotte, NC (US); Daniel Lee Bizzell, Charlotte, NC (US)

(21) Appl. No.: 13/802,717

(22) Filed: Mar. 14, 2013

(51) Int. Cl. A47J 37/06

(52) U.S. Cl. CPC A47J 37/06
USPC 99/403; 99/445; 99/422

(57) ABSTRACT

In another aspect, a cooking grill includes a housing and a lid defining an enclosed cooking chamber when the lid is closed; a heating element located in the housing; and a rack movable between a first location extending over the heating element and a second location not over the heating element. The cooking grill further includes a plurality of grilling modules that are individually removable from, and supported on, the rack. Each grilling module defines a cooking surface having passageways therein for directly exposing food to rising heat from the heating element when the rack is in the first position. The passageways preferably are in the form of slots.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

The present invention generally relates to a cooking grill and, more particularly, to a cooking grill having a cooking chamber containing a rack and plurality of grilling modules supported thereon, whereby different surface configurations can be used to prepare food.

Cooking grills are popular for both outdoor and indoor cooking. Food is cooked on a conventional cooking grill by maintaining it over a heat source on a cooking surface that directly exposes the heat source to the food. A conventional grill comprises a cooking chamber, a grilling surface disposed in the cooking chamber, and one or more heating elements, such as a flame manifold and/or an infrared heater, below the grilling surface within the cooking chamber.

The cooking chamber is typically defined by a metal housing comprising two parts configured in a generally clamshell arrangement, within which the heating elements and the grilling surface are located. Typically, the top half of the housing is hingedly connected to the bottom half of the housing so that the top half of the housing can be tilted up relative to the bottom half in order to provide access to the interior of the cooking chamber, including to the grilling surface, in order to place food on the grilling surface, remove food from the grilling surface, and generally observe the food to determine when cooking of the food is done. The heating elements are coupled to a fuel source, e.g., a self-contained source such as a propane tank mounted to a base of the cooking grill, for generating the heat for cooking. The fuel source for a gas grill is typically propane or natural gas. Another fuel source for grills is charcoal.

The grilling surface typically is disposed above the heating elements inside the cooking chamber. The surface is usually defined by a grilling grate or matrix on which food is directly placed for chargrilling or searing. The grate includes openings through which the food placed on the grate is directly exposed to the heat rising up from the heating elements. The openings are sufficiently small so as to support the food while keeping the food from falling through the grate. Of course, food being grilled normally generates grease and other byproducts during cooking, which can fall through the openings in the grate and cause undesired flame flare-up.

In view of the foregoing, it will become apparent that grills of the prior art suffer from many drawbacks. For instance, the cooking of the food in a cooking grill is the result of two separate phenomena. First, the bottom side of the food that is in contact with the grate is heated directly by the flame and/or contact with the grilling surface of the grate. Second, the entire piece of food is also heated and cooked by means of convection by the heat that builds up inside the cooking chamber. However, every time the top of the cooking chamber is opened, as is frequently necessary to insert, remove, or observe the food being cooked, all of the heat that has built up inside the cooking chamber that cooks the food by convection escapes and cooking by convection essentially halts. When the grill cover is closed again, then the heat can build back up over a certain number of minutes and cooking by convection again commences. Thus, opening the top of the cooking chamber slows down the overall cooking process and wastes fuel. It also ultimately tends to lead to drier food when finally cooked.

Another drawback of conventional cooking grills is that, typically, only one type of cooking, namely, grilling, can be performed. For instance, one cannot fry food in a conventional grill because there is no solid continuous surface on which the food can cook, only the grilling surface, which has openings therein. Also, there is no convenient location in a conventional grill to place water for steaming food.

Yet another drawback of conventional cooking grills is that drippings from the food that is cooked on the grilling surface fall through the openings in the grilling surface onto the flame manifolds and/or the bottom of the cooking chamber. While some buildup of the drippings onto a surface above the flame manifolds may be desirable for adding flavor to food that is cooked, most of the drippings will fall onto the flame manifolds and/or to a bottom surface of the cooking chamber. This is undesirable because the food drippings tend to cause the flame manifolds or bottom surface of the cooking chamber to corrode over time. Hence, the bottom of most cooking grills is sloped toward one central location so that the drippings will flow to a single location in the bottom surface of the cooking chamber where the drippings exit through a hole and into a container disposed beneath the hole. The user can occasionally remove the container, empty its contents, and replace it beneath the hole. This process is performed relatively infrequently and, thus, the process can easily be overlooked. If the user forgets to empty the container and the container overflows, it may damage the deck or other surface on which the cooking grill is placed. Furthermore, as noted above, the container is positioned beneath the bottom of the cooking chamber and, therefore, may be difficult to access.

A solution to one or more of the aforementioned drawbacks is believed to be disclosed in U.S. Pat. No. 8,261,732, which patent is incorporated herein by reference. One or more additional solutions to the aforementioned drawbacks are provided by one or more aspects and features of the present invention, and embodiments thereof, as described herein.

### SUMMARY OF THE INVENTION

The present invention includes many aspects and features. Moreover, while many aspects and features relate to, and are described in, the context of a cooking grill, the present invention is not limited to use only in cooking grills, as will become apparent from the following summaries and detailed descriptions of aspects, features, and one or more embodiments thereof.

Accordingly, an aspect of the present invention relates to a cooking grill apparatus as substantially shown and described below.

In another aspect of the present invention, a cooking grill comprises a housing defining a cooking chamber and a door hinged at a bottom thereof, a heating element disposed in the cooking chamber, and a cooking surface able to slide in and out of the housing.

In another aspect, a cooking grill includes a housing and a lid defining an enclosed cooking chamber when the lid is closed; a heating element located in the housing; and a rack movable between a first location extending over the heating element and a second location not over the heating element. The cooking grill further includes a plurality of grilling modules that are individually removable from, and supported on, the rack. Each grilling module defines a cooking surface having passageways therein for directly exposing food to rising heat from the heating element when the rack is in the first position. The passageways preferably are in the form of slots.

In features of this aspect, at least one grilling module comprises a bottom component and a top component, each having passageways; and the top component is movable relative to the bottom component between a first configuration, in which passageways of the top component register with passageways of the bottom component such that food on the top component is directly exposed to rising heat from the heating element when the rack is in the first position, and a second configuration, in which passageways of the top component do not register with passageways of the bottom component such that food on the top component is not directly exposed to rising heat from the heating element when the rack is in the first position.

In another feature, the grilling component comprises a pan grilling component.

In another feature, the grilling component comprises a griddle grilling component.

In other features, each grilling module is generally rectangular, the rack is generally rectangular, a length of each grilling module approximately equals the length of the rack, and the collective widths of the plurality of grilling modules approximately equals a width of the rack such that the grilling modules substantially cover the cooking area of the rack, the grilling modules predominantly extending front-to-back relative to the cooking chamber.

In still other features, each grilling module is generally rectangular, the rack is generally rectangular, a width of each grilling module approximately equals the width of the rack, and the collective lengths of the plurality of grilling modules approximately equals a length of the rack such that the grilling modules substantially cover the cooking area of the rack, the grilling modules predominantly extending side-to-side relative to the cooking chamber.

In another feature, a bottom component of one of the grilling modules comprising bottom and top components is interchangeable with a bottom component of one of the other grilling modules comprising bottom and top components.

In another feature, the rack comprises between two lateral bars that extend side-to-side and five transverse bars that extend front-to-back, whereby a matrix of eighteen rectangular openings is defined on which the plurality of grilling modules are supported. Preferably, the matrix preferably includes large openings that are incapable of supporting food in direct contact therewith for cooking.

In still other features, the lid defines an opening for accessing the cooking chamber without lifting the lid from the lid-closed position on the housing; the cooking grill further comprises a door that is movable between a door-closed position, wherein the door covers the opening in the lid, and a door-open position, wherein the door does not cover the opening in the lid, and the door includes a handle attached to the door, the handle being the only handle of the cooking grill for opening the lid and the only handle of the cooking grill for opening the door.

In another aspect, a cooking grill comprises a housing that comprises a bottom housing portion and a top housing portion. The top and bottom housing portions are connected for movement of the top housing portion relative to the bottom housing portion between a lid-open position and a lid-closed position. The top and bottom housing portions further define an enclosed cooking chamber when the top housing portion is in the lid-closed position. The top housing portion further comprise: an opening for accessing the cooking chamber without moving the top housing portion from the lid-closed position to the lid-open position; a door movable between a door-closed position, wherein the door covers the opening in the top housing portion, and a door-open position, wherein the door does not cover the opening in the top housing portion; and a handle attached to the door. The door and handle are arranged such that (i) lifting up on the handle when the door is in the door-closed position moves the top housing portion from the lid-closed position toward the lid-open position without moving the door from the door-closed position toward the door-open position, and pulling down on the handle when the door is in the door-closed position moves the door from the door-closed position toward the door-open position without moving the top housing portion from the lid-closed position.

In a feature of this aspect, the handle is the only handle on the top housing portion for moving the top housing portion between the lid-closed and lid-open positions, and the only handle on the top housing portion for moving the door between the door-open and door-closed positions.

In another aspect, a cooking grill comprise: a housing having a top portion and a bottom portion that collectively define a cooking chamber, the top portion defining an opening therein for accessing the cooking chamber therethrough; a heating element located in the cooking chamber; a rack located above the heating element, the rack configured to slide substantially horizontally through the opening in the top portion of the housing into and out of position over the heating element; a plurality of individual grilling modules disposed on the rack and configured to slide with the rack; and a door hingedly coupled to the housing and configured to move between a closed position, in which the door inhibits sliding of the rack through the opening in the top portion of the housing, and an open position, in which the door does not inhibit sliding of the rack through the top portion of the housing. The door extends below the rack when the rack is slid out of the cooking chamber through the opening in the top portion of the housing such that drippings from food cooked on the grilling module that fall through the rack are caught by the door.

Furthermore, one or more grilling modules each comprises: a bottom component having a plurality of passageways and a plurality of protrusions; and a top component having a plurality of passageways and a plurality of alignment openings. The protrusions of the bottom component are received within alignment openings of the top component for substantially aligning the bottom component and the top component when coupled together. The top component is horizontally movable relative to the bottom component between: a first position, in which the passageways of the top and bottom components are aligned for directly exposing food on the grilling module to heat rising from the heating element; and a second position, in which the passageways of the top and bottom components are out of alignment and food on the grilling module is not directly exposed to heat rising from the heating element.

In a feature, the door includes side edges to retain drippings.

In a feature, the rack slides out of the cooking chamber along tracks mounted on the bottom portion of the housing.

In a feature, the rack includes a handle to pull the rack out of the housing.

In a feature, the rack includes a side edge to secure the assembly of grilling modules on the rack.

In a feature, when the passageways of the top and bottom components of a particular one of the plurality of grilling modules are substantially out of alignment, channels are formed in the top component. The channels preferably are watertight, whereby a fluid may be contained within the top component. In this respect, the particular one of the plurality of grilling modules may be a pan grilling component.

In another feature, when the passageways of the top and bottom components of a particular one of the plurality of grilling modules are substantially out of alignment, the top component is capable of retaining liquid for steaming in the cooking chamber. The particular one of the plurality of grilling modules may be a pan grilling component.

In a feature, a particular one of the plurality of grilling modules is a pan grilling component, and a top component of the pan grilling component comprises collapsible walls whereby the top component is capable of being laid flat for storage.

In another aspect, a method of cooking uses grilling components and a cooking grill as disclosed herein.

In another aspect, an assembly of grilling modules as disclosed herein is used for cooking food on a cooking grill.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

Further features, embodiments, and advantages of the present invention will become apparent from the following detailed description with reference to the drawings.

FIG. 1A is an isometric view of a cooking grill in accordance with one or more preferred embodiments of the present invention.

FIG. 1B is an isometric view of the cooking grill of FIG. 1A with base panels omitted.

FIG. 1C is a front view of the cooking grill of FIG. 1B.

FIG. 1D is a back view of the cooking grill of FIG. 1B.

FIG. 1E is a left side view of the cooking grill of FIG. 1B.

FIG. 1F is a right side view of the cooking grill of FIG. 1B.

FIG. 1G is a top plan view of the cooking grill of FIG. 1B.

FIG. 2A is another isometric view of the cooking grill of FIG. 1A.

FIG. 2B is an isometric view of a cooking grill of FIG. 2A including grilling modules in accordance with one or more preferred embodiments of the present invention.

FIG. 2C is a front view of the cooking grill of FIG. 2B.

FIG. 2D is a side view of the cooking grill of FIG. 2B.

FIG. 2E is a top view of the cooking grill of FIG. 2B.

FIG. 3A is another isometric view of the cooking grill of FIG. 1A.

FIG. 3B is an isometric view of the cooking grill of FIG. 3A including grilling modules in accordance with one or more preferred embodiments of the present invention.

FIG. 4A is an isometric view of the exemplary grilling modules shown in the foregoing figures.

FIG. 4B is another isometric view of the grilling modules of FIG. 4A.

FIG. 4C is an isometric exploded view of the grilling modules of FIG. 4A.

FIG. 5 is an exploded view of the grilling rack and exemplary grilling modules shown in the foregoing figures.

FIG. 6A is a perspective view of the grilling rack of the foregoing figures.

FIG. 6B is a top plan view of the grilling rack of FIG. 6A.

FIG. 7A is a top plan view of the grilling rack of FIG. 6B and a griddle grilling module positioned thereon, wherein the slots are in an open position.

FIG. 7B is a top plan view of the grilling rack and a griddle grilling module of FIG. 7A, wherein the slots are in a closed position.

FIG. 8A is a perspective exploded view of the griddle grilling module of FIG. 7B.

FIG. 8B is a front elevational view of the griddle grilling module of FIG. 8A.

FIG. 8C is a side elevational view of the griddle grilling module of FIG. 8A.

FIG. 9A is a front plan view of another embodiment of a cooking grill in accordance with one or more preferred embodiments of the present invention.

FIG. 9B is a side plan view of the cooking grill of FIG. 9A.

FIG. 9C is a top plan view of the cooking grill of FIG. 9A.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

FIG. 1A is an isometric view of a cooking grill 10 in accordance with one or more preferred embodiments of the present invention. As seen in FIG. 1A, the cooking grill 10 comprises a base or stand portion 12 comprising a plurality of legs 14 for supporting it on the ground or other horizontal surface, a shelf 16 for storage of items such as cooking supplies, cooking utensils, etc., and a shelf 18 comprising a side burner 40 for additional side cooking. The stand portion 12 may be open, enclosed on one or more sides, or enclosed on all sides by base panels 42. If enclosed on all sides, preferably one of the sides comprises a door for permitting access to an interior of the stand portion.

At this juncture it should be noted that the terms “vertical” and “horizontal” as used herein are not intended to imply a specific orientation relative to the earth, but are used relative to the cooking grill 10 as shown in the drawings in order to describe the components of the cooking grill 10 as they would be oriented when the cooking grill 10 is used in a conventional manner, standing upright on level ground.

FIG. 1B is an isometric view of the cooking grill 10 with the base panels 42 omitted. As can be seen in FIG. 1B, the cooking grill 10 contains a fuel source, typically self-contained, such as a propane tank 20, mounted somewhere on the base 12. As shown in FIG. 1B, the cooking grill 10 includes a shelf 44 extending between the legs 14 on which the tank 20 is supported. A fuel hose 46 typically extends from the fuel source 20 to one or more heating elements, such as flame manifolds covered by diffusers 24 (not shown in FIG. 1B, but partially shown in FIGS. 2A and 3A). The diffusers 24 are disposed inside of a cooking chamber 26 (shown in FIGS. 2A and 3A) defined by bottom and top portions 28a, 28b of a housing 28. In the cooking grill 10, three diffusers 24 run front-to-back of the housing; however, this is merely exemplary, as the number of flame manifolds and diffusers 24 may be more or less than three and they alternately may run from side to side rather than front to back.

In other embodiments, the cooking grill 10 is connected to a permanent source of fuel, such as a household natural gas line. and the tank 20 is omitted. In other embodiments, the fuel source may be wood, coal or any other combustible material contained entirely within the housing.

The cooking chamber defined by the housing 28 encloses an interior cooking space. The bottom portion 28a and top portion 28b are connected to each other by a pivot hinge 30 at the back of the housing 28, best shown in FIGS. 1D and 1E. The top portion 28b comprises a door 32 attached by a pivot hinge 34 at the front of housing 28. The door 32 may be comprised of the same material as housing 28 or may be partially or completely a transparent material to allow a user to view the interior of cooking chamber 26 without opening the door 32. Preferably, the door 32 comprises of a high temperature glass through which the interior of cooking chamber 26 may be viewed.

A handle 46 is located on the front of the top housing portion 28b and is attached to the door 32 whereby a person may either grasp the handle 46 and push in the direction of arrow B tilting the top half housing portion 28b up about the hinge 30 toward the position shown in FIG. 3A, or pull in the direction of arrow A tilting the door 32 of the top half housing portion 28b down about the hinge 34 toward the position shown in FIG. 2A.

FIG. 1C is a front view of the cooking grill 10 of FIG. 1B. As can be seen in FIG. 1C, the cooking grill 10 is equipped with controls for operating the grill, such as a spark igniter and rotary knobs 38 for controlling the rate of gas flow to the flame manifolds and diffusers 24 to control the temperature within the cooking chamber 28. The cooking grill 10 is equipped with at least one control, such as a rotary knob 39 on shelf 18, for controlling the rate of gas flow to side burner 40 (shown in FIG. 1G). While the controls 36 are shown in front of the housing, they may be placed anywhere, such as on the side of the housing. Furthermore, as can be seen in FIG. 1C the cooking grill 10 is equipped with shelf 16 used for storage of items, such as cooking supplies, and may also include at least one hook 48 for hanging cooking utensils.

FIG. 1D is a back view of the cooking grill 10 of FIG. 1B. As can be seen in FIG. 1D, hinge 30 run in the direction of side-to-side of the housing 28 allowing for housing top half portion 28b, i.e., the lid of the cooking grill 10, to be tilted up about hinge 30 relative to bottom housing portion 28a, such as shown in FIG. 3A.

FIGS. 1E and 1F are side views of the cooking grill 10 of FIG. 1B, and further illustrate the connection of the bottom housing portion 28a and top housing portion 28b by the pivot hinge 30 at the back of the housing 28. As also shown in FIGS. 1E and 1F, shelf 16, shelf 18 and rotary knobs 38 and 39 attached to bottom housing portion 28a.

FIG. 1G is a top plan view of the cooking grill 10 of FIG. 1B, and further illustrates the shelf 18 with side burner 40, rotary knob controllers 38, handle 46 disposed on the front of the top housing portion 28b, and storage shelf 16 with hooks 48. While the hooks 48 are shown in side of the storage shelf 16, they may be placed anywhere on cooking grill 10, such as on the front of shelf 16 or on shelf 18.

FIG. 2A is an isometric view of the cooking grill 10 with the door 32 in an open position to reveal a rack 50 of the cooking grill 10 that has been slid out from the cooking chamber 26. The rack 50 defines a support area 52 and side edges 54. As perhaps best shown in FIGS. 6A and 6B, the support area 52 of the rack 50 preferably includes two lateral bars 552, 554 that extend side-to-side and five transverse bars 556-564 that extend front-to-back between a periphery, whereby a matrix of eighteen rectangular openings is defined. The matrix preferably includes large opening 566 that are simply incapable of directly supporting in contact thereof food for cooking, such as hotdogs and hamburgers. A handle 56 is located on a front of the rack 50 for facilitating sliding of the rack 50 from and insertion of the rack 50 into the cooking chamber 26 by sliding movement.

In particular, the rack 50 is slid out from the cooking chamber 26 by first pulling the door 32 down about the hinge 34 via the handle 46 in order to gain access to the interior of the cooking chamber 26. With door 32 open and access uninhibited, the handle 56 is grasped and the rack 50 is slid horizontally outwardly along tracks 58. Alternatively, the rack 50 is slid out from the cooking chamber 26 by first lifting the lid 28b up about the hinge 30 via the handle 46 in order to gain access to the interior of the cooking chamber 26. With the lid 28b open and access uninhibited, the handle 56 is grasped and the rack 50 is slid horizontally outwardly along tracks 58.

The tracks 58 are mounted on the sides of the bottom housing portion 28a of housing 28. Rack 50 is disposed on—and may be mounted or otherwise retained to—tracks 58 for sliding. As shown, rack 50 simply rests and slides on track 58, and the rack and dimensions of the housing are such that the rack remains disposed on track 58 while the grill is assembled and used. Alternatively, rollers may be included for rolling of the rack 50 as opposed to sliding. Preferably, the rack 50 is completely removable from the cooking chamber 26 by being slid out of the cooking chamber 26 and lifted up and away from the housing 28. Removal of the rack 50 may permit the user to carry it away from cooking grill 10 for cleaning as well as enable easier access to the cooking chamber 26 for cleaning.

FIG. 2B is an isometric view of the cooking grill 10 with the door 32 open and the rack 50 pulled out from the cooking chamber 26. As shown in FIG. 2B, an assembly of grilling modules 60 are supported on the rack 50. Unlike the rack 50, the assembly of grilling modules 60 collectively provide the surface for cooking food within the cooking chamber 26.

The assembly of grilling modules 60 perhaps are best seen in FIGS. 4A, 4B, and 4C, wherein three different grilling modules 60 are shown. Each grilling module 60 in the assembly preferably comprises at least a slotted panel 62, and may comprise an additional top component. The slotted panel 62 in at least some embodiment thereof provides a cooking surface similar to that of grates of conventional cooking grills, wherein openings or slots are provided for exposing food to heat and flame.

As illustrated in the drawings, the assembly of grilling modules 60 comprises three generally rectangular slotted panels 62 that, collectively, make up the support area 52 of the rack 50. Furthermore, it is acknowledged that it may be practical for a grill rack 50 to be covered by more than three or less than grilling modules 60, and therefore, two or more than three grilling modules may be used of either the same or dissimilar sizes. Nonetheless, it is preferred that a sufficient number and sized grilling modules be provided so as to completely cover the support area 52 of the rack 50. Furthermore, additional, alternative grilling modules may be provided for substitution of other grilling modules on demand depending on the type of cooking desired at a given time.

Each panel 62 preferably includes vertical posts or protrusions 64 by which an additional, top component of a grilling module 60 may be retained for sliding alignment on top of the panel 62. The griddle grilling module 66 and pan grilling module 68 and exemplary top components, described in greater detail below. In this respect, such additional top component preferably includes alignment openings 70 for receiving the protrusions 64. The alignment openings may extend entirely through the top component, as shown in the drawings, or the alignment openings may constitute recesses that only extend partially through the top component and not entirely through the top component. Nonetheless, in this case the alignment openings preferably are sufficiently deep to permit abutment of a bottom surface of the top component with the top surface of the panel 62 whereby slots in the top component are essentially closed off by the top surface of the panel 62 when the top component is slid into a closed position, as described in greater detail below.

With particular regard to the griddle grilling module 66, the top component thereof preferably comprises a rectangular slotted plate with alignment opening 70 capable of receiving protrusions 64. Preferably, alignment openings 70 are of sufficient length to allow slots 72 on panel 62 to selectively align and misalign with slots 74 defined in the top component of the griddle grilling module 66, thereby enabling selective exposure to rising heat and flame of the food cooking on the surface of the griddle grilling module 66. The griddle grilling module 66 is shown with open slots in FIG. 4A and with closed slots in FIG. 4B. This is further shown and illustrated in FIGS. 7A (open slots) and 7B (closed slots). Furthermore, the relationship between the panel 62 of the griddle grilling module 66 and top component 63 is illustrated in the exploded views of FIGS. 8A, 8B, and 8C.

With particular regard to the pan grilling module 68, the top component thereof preferably comprises a rectangular base 76 with alignment openings 70 capable of receiving protrusions 64. The top component further comprises a peripheral wall 78 that extends around the base 76 and defines a wall for containing food items placed on the base 76. The base 76 defines slots 82 and, preferably, the alignment openings 70 are of sufficient length to allow slots 82 on surface 76 to selectively align and misalign with slots 72 on panel 62 during sliding of the top component on top of the panel 62.

Each top component of a grilling module 60 rests on a panel 62 which itself is supported on the area 52 of the rack 50 between side edges 54, and the top component, the panel 62 (if the grilling component 60 consists of jut the panel 62), or the entire grilling component (panel 62 and top component combined) may be placed on or lifted off of the rack 50 before, during, or after cooking. For example, removal of a grilling module 60 or top component thereof may permit the user to carry the grilling module 60 or top component thereof from the cooking grill 10, such as to a refrigerator or kitchen counter prior to cooking to place the food on the grilling module 60 or top component thereof, rather than bringing the food to the cooking grill 10 on a separate tray or plate. The user then can place a grilling module 60 or top component thereof on the rack 50 and close the top housing portion 28b or door 32 for commencing cooking.

During cooking, misalignment of slots in a panel 62 and slots in a top component of a grilling module 60 will close the slots and protect food from direct exposure to rising heat and flame. This may be desired when certain food needs to be cooked at a slower rate than other food, or when a different cooking technique is to be used that does not lend itself to such direct exposure. Moreover, a user can access rack 50 and grilling module 60 by opening door 32 while food is cooking in order to align or misalign slots of one or more of the grilling modules without the need to open the lid 28b of the cooking grill 10. By not opening the lid 28b and instead opening the door 32, it is believed that much less heat escapes from the cooking chamber 26.

FIG. 2C is a front view of the cooking grill 10 of FIG. 2B and further illustrates handle 56 disposed on the front of rack 50 used to facilitate the horizontal outward sliding of rack 50 from cooking chamber 26; and the assembly of grilling modules 60 sitting freely on the rack 50. Further as shown, griddle grilling module 66 includes handle 77 to facilitate the horizontal sliding of griddle grilling module 66 along panel 62. While the handle 77 is shown in front of griddle grilling module 66, it may be placed anywhere, such as on the back of the griddle grilling module 66. Preferably, the pan grilling module 68 includes handle 80 to facilitate the horizontal sliding of pan grilling module 68 along panel 62. While the handle 80 is shown in front of pan grilling module 68, it similarly may be placed anywhere, such as on the back or side of the pan grilling module 68.

FIG. 2D is a side views of the cooking grill 10 of FIG. 2B, and further illustrates the side edges 54 of the rack 50 that secure the assembly of grilling modules 60 on top of the rack 50. It will also be appreciated that with further reference to FIG. 2D, the door 32 is sufficiently sized and shaped so as to catch drippings that may fall from the assembly of grilling modules 60 through the rack 50. Preferably, the door 32 includes an edge 82 capable of retaining such drippings.

FIG. 2E is a top view of the cooking grill 10 of FIG. 2B. As shown in FIG. 2E, slots 72 on panel 62 of the griddle grilling component 66 are aligned with slots 74 on the top component of the griddle grilling module 66, and slots 72 on panel 62 of the pan grilling module 68 are aligned with slots 82 on the top component of the pan grilling module 68.

FIG. 3A is an isometric view of the cooking grill 10 with the lid 28b open and the rack 50 in located in the cooking chamber 26. As described above, the rack 50 may be slid out of the cooking chamber 26 along tracks 58 mounted on the sides of bottom housing portion 28a of housing 28. Sliding the rack 50 out may be preferable where the user may wish to add food to rack 50 and then slide rack 50 back into cooking chamber 26. An assembly of grilling components 60 is shown disposed on the rack 50 in FIG. 3B. The user wishing to rapidly dissipate heat from cooking chamber 26 may open the lid 28b as shown in FIG. 3B. When top housing portion 28b is open, the grilling modules 60 sitting on rack 50 and may be directly removed from the rack 50 without sliding the rack out of the cooking chamber 26, if desired.

FIG. 4A is an isometric view of an exemplary assembly of grilling modules 60 each in an open position. As shown, slots 72 on panel 62 of the griddle grilling module 66 align with slots 74, and slots 72 on panel 62 of the pan grilling module 68 align with slots 82. In contrast, FIG. 4B is an isometric view of the exemplary assembly of grilling modules 60 each in a closed position. As shown, slots 72 on panel 62 of the griddle grilling module 66 are misaligned with slots 74, and slots 72 on panel 62 of the pan grilling module 68 are misaligned with slots 82.

It will be appreciated that the peripheral wall 78 allows the pan grilling module 68 to retain a layer of water, which may be heated by the flame so that the cooking grill may alternately be used as a steamer, if desired, as well as a conventional grill.

In a further feature of the pan grilling module 68, the pan grilling module 68 can be equipped with a peripheral wall 78 that is pivotably movable relative to base 76 to permit the collapse of pan grilling module 68 to a flat configuration for storing. Such pan technology is known from a baking pan having collapsible walls, disclosed in U.S. Patent Application Publication 2012/0104006, which is incorporated herein by reference.

FIG. 4C is an exploded isometric view of the assembly of grilling modules 60 of FIG. 4B. As seen in FIG. 4C each of the panels 62 of the preferred assembly are the same and are preferably interchangeable with one another. The lengths of the grilling modules 60 correspond to the length of the grill rack 50, and the widths of the grilling modules 60 collectively correspond to the width of the rack 50. The slots 72 on the panels 62 preferably are of equally size. The pan grilling module 68 comprises generally a rectangular base 76 and a peripheral wall 78 extending there around, and the base 76 preferably defines slots 82 therein that are approximately equal to half the length of the slots defined in the panel 62. The rack 50, grilling modules 60 all may be coated with Teflon or another non-stick surface treating in order to provide non-stick surfaces.

Advantages of the cooking grill 10 include enhanced safety, convenience, and comfort. Specifically, the user of the cooking grill 10 need not reach directly over the flames in order to manipulate or view the food as a user would if using a conventional grill, which, at a minimum, can be rather uncomfortable since the user would be placing his or her hand or face directly into the heated air rising within the cooking chamber. With the cooking grill 10, the user can instead horizontally slide the food from the cooking chamber to view and manipulate the food, while avoiding unnecessary heal loss from opening the lid. Furthermore, the user may safely remove food from any flame-ups caused by flammable drippings without need to open up the lid. Moreover, such flame-ups generally remain contained within the cooking chamber.

Yet another embodiment of a cooking grill 100 is shown in FIGS. 9A, 9B, and 9C. Cooking grill 100 is similar in construction to the cooking grill 10, and primarily differs in the double doors located on the front of the stand portion, which provide access to the storage area underneath the housing.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

For example, in some alternate embodiments, the grilling module may include a lower panel and top component that are be attached as one unit and not removable from each other, but in which slots in the top component nonetheless may be opened and closed for selective exposure of food to rising heat and flame.

In another example, grilling modules may have a configuration other than slots as shown and described above. In this respect, other configurations permitting exposure to rising heat and flame may be used, hereinafter passageways which include the aforementioned slots and also may include other configurations such as holes in place of the slots, provided that any align and misalignment of the slots described above continues to apply to such other configurations.

1. A cooking grill, comprising: a housing; a lid defining an enclosed cooking chamber when the lid is closed; a heating element located in the housing; a rack movable between a first location extending over the heating element and a second location not over the heating element; and a plurality of grilling modules removably supported on the rack, each grilling module defining a cooking surface having passageways therein for directly exposing food to rising heat from the heating element when the rack is in the first position.

2. The cooking grill of claim 1, wherein at least one grilling module comprises a bottom component and a top component, each having passageways, and wherein the top component is movable relative to the bottom component between a first configuration, in which passageways of the top component register with passageways of the bottom component such that food on the top component is directly exposed to rising heat from the heating element when the rack is in the first position, and a second configuration, in which passageways of the top component do not register with passageways of the bottom component such that food on the top component is not directly exposed to rising heat from the heating element when the rack is in the first position.

3. The cooking grill of claim 1, wherein the grilling component comprises a pan grilling component.

4. The cooking grill of claim 1, wherein the grilling component comprises a griddle grilling component.

5. The cooking grill of claim 1, wherein each grilling module is generally rectangular, wherein the rack is generally rectangular, wherein a length of each grilling module approximately equals the length of the rack, and wherein the collective widths of the plurality of grilling modules approximately equals a width of the rack such that the grilling modules substantially cover the cooking area of the rack, the grilling modules predominantly extending front-to-back relative to the cooking chamber.

6. The cooking grill of claim 1, wherein each grilling module is generally rectangular, wherein the rack is generally rectangular, wherein a width of each grilling module approximately equals the width of the rack, and wherein the collective lengths of the plurality of grilling modules approximately equals a length of the rack such that the grilling modules substantially cover the cooking area of the rack, the grilling modules predominantly extending side-to-side relative to the cooking chamber.

7. (canceled)

8. The cooking grill of claim 1, wherein the rack comprises between two lateral bars that extend side-to-side and transverse bars that extend front-to-back, whereby rectangular openings is defined on which the plurality of grilling modules are supported.

9. (canceled)

10. The cooking grill of claim 1, wherein the lid defines an opening for accessing the cooking chamber without lifting the lid from the lid-closed position on the housing; wherein the cooking grill further comprises a door that is movable between a door-closed position, wherein the door covers the opening in the lid, and a door-open position, wherein the door does not cover the opening in the lid, and wherein the door includes a handle attached to the door, the handle being the only handle of the cooking grill for opening the lid and the only handle of the cooking grill for opening the door.

11. A cooking grill, comprising a housing comprising a bottom housing portion and a top housing portion, the top and bottom housing portions being connected for movement of the top housing portion relative to the bottom housing portion between a lid-open position and a lid-closed position, the top and bottom housing portions defining an enclosed cooking chamber when the top housing portion is in the lid-closed position, the top housing portion further comprising:
(a) an opening for accessing the cooking chamber without moving the top housing portion from the lid-closed position to the lid-open position;
(b) a door movable between a door-closed position, wherein the door covers the opening in the top housing portion, and a door-open position, wherein the door does not cover the opening in the top housing portion; and
(c) a handle attached to the door;
(d) wherein the door and handle are arranged such that,
(i) lifting up on the handle when the door is in the door-closed position moves the top housing portion from the lid-closed position toward the lid-open position without moving the door from the door-closed position toward the door-open position, and
(ii) pulling down on the handle when the door is in the door-closed position moves the door from the door-closed position toward the door-open position without moving the top housing portion from the lid-closed position.

12. (canceled)

13. A cooking grill, comprising:
(a) a housing having a top portion and a bottom portion that collectively define a cooking chamber, the top portion defining an opening therein for accessing the cooking chamber therethrough;
(b) a heating element located in the cooking chamber;
(c) a rack located above the heating element, the rack configured to slide substantially horizontally through the opening in the top portion of the housing into and out of position over the heating element;
(d) a plurality of individual grilling modules disposed on the rack and configured to slide with the rack; and
(e) a door hingedly coupled to the housing and configured to move between a closed position, in which the door inhibits sliding of the rack through the opening in the top portion of the housing, and an open position, in which the door does not inhibit sliding of the rack through the top portion of the housing;
(f) wherein the door extends below the rack when the rack is slid out of the cooking chamber through the opening in the top portion of the housing such that drippings from food cooked on the grilling module that fall through the rack are caught by the door; and
(g) wherein one or more grilling modules each comprises,
(i) a bottom component having a plurality of passageways and a plurality of protrusions, and
(ii) a top component having a plurality of passageways and a plurality of alignment openings,
(iii) wherein protrusions of the bottom component are received within alignment openings of the top component for substantially aligning the bottom component and the top component when coupled together, and
(iv) wherein the top component is horizontally movable relative to the bottom component between,
(A) a first position, in which the passageways of the top and bottom components are aligned for directly exposing food on the grilling module to heat rising from the heating element, and
(B) a second position, in which the passageways of the top and bottom components are out of alignment and food on the grilling module is not directly exposed to heat rising from the heating element.

14. The cooking grill of claim 13, wherein the door includes side edges to retain drippings.

15. The cooking grill of claim 13, wherein the rack slides out of the cooking chamber along tracks mounted on the bottom portion of the housing.

16. The cooking grill of claim 13, wherein the rack includes a handle to pull the rack out of the housing.

17. The cooking grill of claim 13, wherein the rack includes a side edge to secure the assembly of grilling modules on the rack.

18. The cooking grill of claim 13, wherein, when the passageways of the top and bottom components of a particular one of the plurality of grilling modules are substantially out of alignment, channels are formed in the top component.

19. The cooking grill of claim 18, wherein the channels are water tight, whereby a fluid may be contained within the top component.

20. The cooking grill of claim 19, wherein the particular one of the plurality of grilling modules is a pan grilling component.

21. The cooking grill of claim 13, wherein, when the passageways of the top and bottom components of a particular one of the plurality of grilling modules are substantially out of alignment, the top component is capable of retaining liquid for steaming in the cooking chamber.

22. The cooking grill of claim 21, wherein the particular one of the plurality of grilling modules is a pan grilling component.

23. The cooking grill of claim 13, wherein a particular one of the plurality of grilling modules is a pan grilling component, and wherein a top component of the pan grilling component comprises collapsible walls whereby the top component is capable of being laid flat for storage.

24. (canceled)

25. (canceled)
